(19) United States
(12) Patent Application Publication
(10) Pub. No.: US 2015/0345753 A1
(43) Pub. Date: Dec. 3, 2015

(54) LIGHTING APPARATUS

(71) Applicant: YAZAKI CORPORATION, Tokyo (JP)

(72) Inventor: Shinji Mochizuki, Shizuoka (JP)

(21) Appl. No.: 14/824,258

(22) Filed: Aug. 12, 2015

Related U.S. Application Data
(63) Continuation of application No. PCT/JP2014/053363, filed on Feb. 13, 2014.

(30) Foreign Application Priority Data
Feb. 14, 2013 (JP) 2013-027061

(51) Int. Cl. F21V 17/10; F21V 17/00; F21V 5/04

(52) U.S. Cl. CPC F21V 17/104; F21V 5/04; F21V 17/005; F21Y 2101/02

(57) ABSTRACT

An LED unit includes a housing accommodating an LED, a cover that is mounted on the housing, a lens mounting opening and a lens insertion guide groove which are formed in the cover, and a guide rod that guides insertion of a lens protruded along a lens center axis to a lens seating section and abuts the LED when the cover is mounted on the housing.

### CROSS REFERENCE TO RELATED APPLICATIONS

This application is a continuation of PCT application No. PCT/JP2014/053363, which was filed on Feb. 13, 2014 based on Japanese Patent Application (No. 2013-027061) filed on Feb. 14, 2013, the contents of which are incorporated herein by reference.

### BACKGROUND OF THE INVENTION

1. Field of the Invention

The present invention relates to a lighting apparatus including a semiconductor light emitting device such as an LED.

2. Description of the Related Art

An LED unit (lighting apparatus) including a semiconductor light emitting device such as a Light Emitting Diode (LED), a housing that accommodates the semiconductor light emitting device, a cover that is mounted on the housing, and a lens that is provided in the cover and refracts an emitted light from the semiconductor light emitting device is disclosed in PTL 1.

As illustrated in FIG. 8, the LED unit is configured such that a pair of busbars 501 and 503 are assembled and a semiconductor light emitting device (LED) 505 that is a light source is assembled in a housing (not illustrated). The busbars 501 and 503 having a flat plate shape and divided into two busbars have an electric wire connection section 507, a Zener diode connection section 509, a resistor connection section 511, and an LED connection section 513. In the resistor connection section 511, the pressure contact blades 515 and 515 are respectively included in each of the two-divided busbars 501 and 503. In the Zener diode connection section 509, a single pressure contact blade 517 is included in one busbar 501 and a single pressure contact blade 519 is included in the other busbar 503.

A Zener diode 521 is configured such that one lead section 523 is electrically connected to one busbar 501 and the other lead section 525 is electrically connected to the other busbar 503, is connected in parallel to the pair of busbars 501 and 503 on a downstream side of a resistor 527, and performs functions of protecting the semiconductor light emitting device 505 from damage against a sudden large voltage applied to a circuit by static electricity in a direction in which a forward electromotive force flows in the Zener diode 521, preventing the Zener diode 521 from being energized in a direction in which a reverse electromotive force flows through the Zener diode 521, and similarly, preventing the semiconductor light emitting device from being damaged.

In the LED unit described above, a lead-type semiconductor light emitting device 505 in which the lens section is integrated is used. Thus, it is not necessary to match positions of the lens section and a light emitting section.

On the other hand, in the LED unit having the semiconductor light emitting device, there is a LED unit on which a chip-type semiconductor light emitting device having a separately provided lens is mounted (see PTL 2).

[PTL 1] JP-A-2007-149762

[PTL 2] JP-A-2012-113833

### SUMMARY OF THE INVENTION

However, in the LED unit on which the chip-type semiconductor light emitting device is mounted, a housing mounting the semiconductor light emitting device and a cover mounting the lens are integrally assembled. Thus, there is a problem that relative positioning of the chip-type semiconductor light emitting device and the lens is difficult. Furthermore, since one surface of a general lens for condensing light has a flat disk shape and is a convex curved surface, there is a problem that the lens is unlikely to be held by a chuck and the like which are used during automated assembly and positioning is difficult during the assembly.

The invention has been made in view of the above circumstances and an object of the invention is to provide a lighting apparatus including a lens accommodating structure in which positioning of a semiconductor light emitting device and a lens can be relatively easily performed.

The object of the invention is achieved by the following configurations.

(1) A lighting apparatus includes: a semiconductor light emitting device; a housing in which an element mounting opening of an element mounting space accommodating the semiconductor light emitting device is opened in one outer surface and in which a light emitting opening communicated with the element mounting space is provide in a perpendicular outer surface perpendicular to the one outer surface; a cover that allows the one outer surface to enter a lens mounting space accommodating a lens for refracting an emitted light from the semiconductor light emitting device and is mounted on the housing; a lens mounting opening that is formed in the cover and is opened on a side opposite to a lens seating section on a rear side with the one outer surface entered in the lens mounting space interposed therebetween; a lens insertion guide groove that is formed over the lens seating section from the lens mounting opening; and a guide rod that protrudes from a light incident side of the lens along a lens center axis, engages with the lens insertion guide groove so as to guide insertion of the lens to the lens seating section, and abuts the semiconductor light emitting device when the cover is mounted on the housing.

According to the lighting apparatus having the configuration of (1) described above, the guide rod is protruded from the light incident side of the lens along the lens center axis, the guide rod is held by the chuck during automated assembly, and it is possible to reliably hold the lens in a desired posture. The lens held by the guide rod is inserted into the lens mounting space from the lens mounting opening and is mounted on the lens seating section on the rear side while the guide rod engages with the lens insertion guide groove of the cover and is guided to insert.

The cover is mounted on the housing on which the semiconductor light emitting device is mounted in a state where the lens is mounted. If the cover is mounted on the housing, one outer surface of the housing enters the lens mounting space. The element mounting opening is opened in the one outer surface of the housing. Here, if the semiconductor light emitting device is not completely mounted (semi-engaged) in the element mounting space, an insertion rear end section is in a state of protruding from the element mounting opening. The semiconductor light emitting device, in which the insertion rear end section protrudes from the element mounting opening, abuts the guide rod engaging with the lens insertion guide groove, if the one outer surface of the housing enters the lens mounting space.

If the cover is mounted on the housing to a predetermined position, the semiconductor light emitting device is pressed to a predetermined position of the element mounting space by the guide rod abutting the insertion rear end section and is in a regular mounting position. In this case, since the semiconductor light emitting device is directly pressed by the guide rod integrally formed with the lens, an error in a relative position with the lens is unlikely to occur.

(2) In the lighting apparatus according to (1), the guide rod is integrally molded with the lens by a transparent material.

According to the lighting apparatus having the configuration of (2) described above, if the semiconductor light emitting device has a size which allows it to be disposed on an inside of an outer diameter of the lens, the guide rod is protruded and formed on the inside from the outer diameter of the lens, but since the guide rod is formed of the transparent material, the guide rod does not block the light until the light is incident on a light incident side of the lens from the semiconductor light emitting device.

(3) In the lighting apparatus according to (1) or (2), a positioning section is formed in the element mounting space with the semiconductor light emitting device interposed between the guide rod and the positioning section.

According to the lighting apparatus having the configuration of (3) described above, the semiconductor light emitting device pressed against the guide rod abuts the positioning section, is stopped, and is not pressed to a predetermined position or more. The semiconductor light emitting device is interposed between the guide rod and the positioning section, and thus the semiconductor light emitting device is unlikely to move due to vibration or impact and fixing reliability is increased.

As described above, the invention is briefly described. Furthermore, details of the invention will be further clarified by reading through modes (hereinafter, referred to as “embodiments”) for carrying out the invention described later with reference to the accompanying drawings.

### BRIEF DESCRIPTION OF THE DRAWINGS

FIG. 1 is an exploded perspective view of a lighting apparatus including a lens accommodating structure according to an embodiment of the invention.

FIG. 2A is an external perspective view of a state where the lighting apparatus illustrated in FIG. 1 is assembled, which is viewed from a light emitting side and FIG. 2B is an external perspective view of the lighting apparatus of FIG. 2A, which is viewed from a lens mounting opening side.

FIG. 3 is an external perspective view illustrating a modification example of a cover in the lighting apparatus illustrated in FIG. 2A.

FIG. 4A is an exploded perspective view illustrating a terminal mounting step, FIG. 4B is a plan view illustrating a terminal cutting step, and FIG. 4C is an exploded perspective view illustrating an electronic component mounting step.

FIG. 5A is an exploded perspective view illustrating a light emitting element mounting step, FIG. 5B is an exploded perspective view of a resistor mounting step, and FIG. 5C is an exploded perspective view illustrating a lens mounting step.

FIG. 6A is an exploded perspective view illustrating a cover mounting step, FIG. 6B is an exploded perspective view illustrating an electric wire assembling step, and FIG. 6C is an exploded perspective view illustrating an electric wire holder mounting step.

FIG. 7A is a plan view of the lighting apparatus of which assembling is completed, which is viewed from the lens mounting opening side and FIG. 7B is a sectional view that is taken along line A-A of FIG. 7A.

FIG. 8 is a perspective view of a main portion of an LED unit of the related art.

### DETAILED DESCRIPTION OF THE EXEMPLARY EMBODIMENTS

Hereinafter, an embodiment of the invention will be described with reference to the drawings.

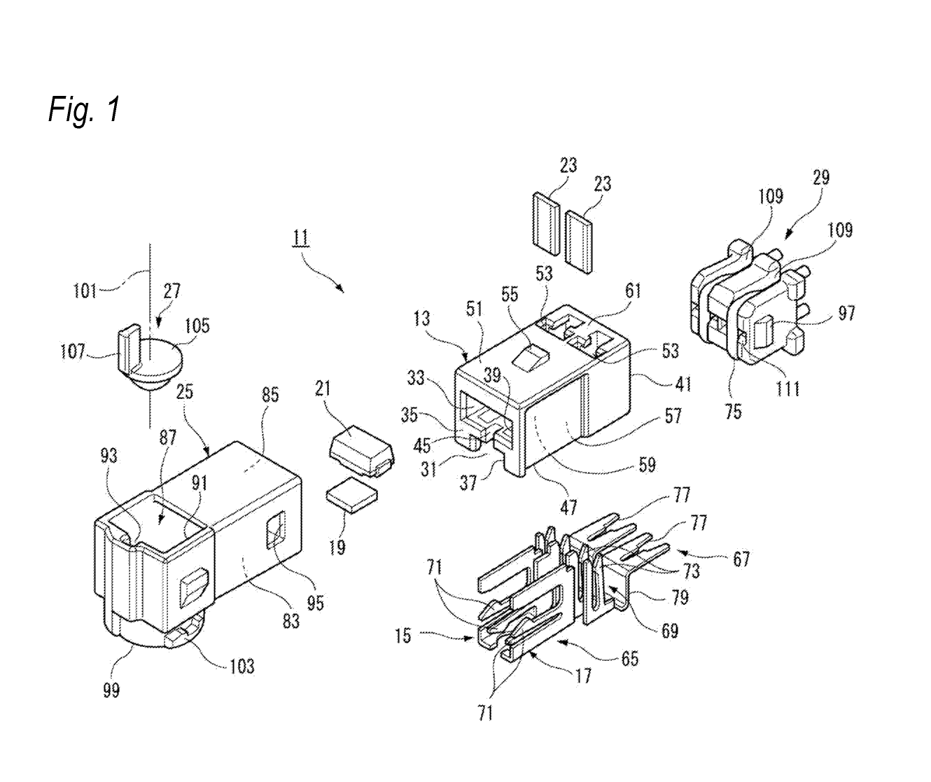

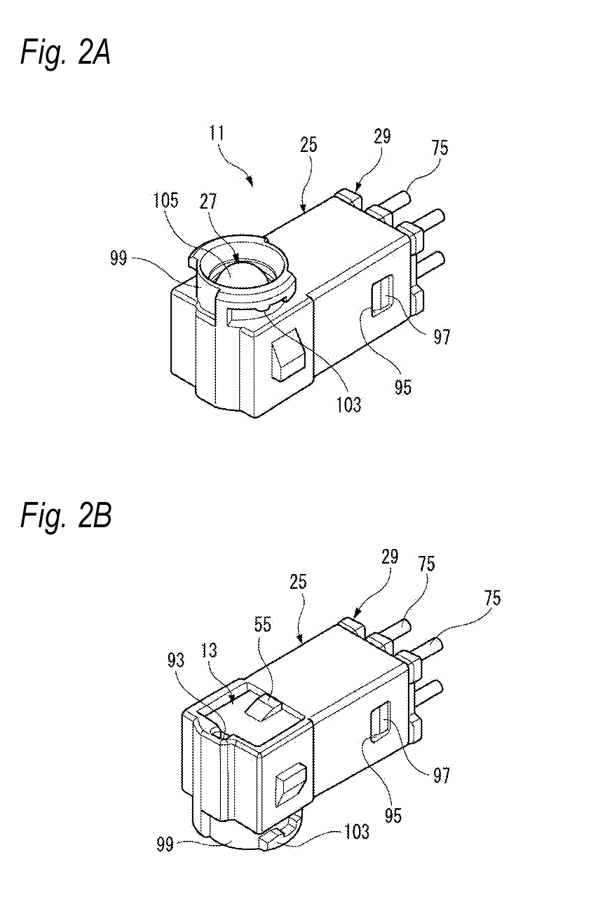

As illustrated in FIG. 1, an LED unit 11 that is a lighting apparatus including a lens accommodating structure according to the embodiment has a housing 13, a left busbar 15 and a right busbar 17 that are busbars, terminals, an LED 19 that is a chip-type semiconductor light emitting device, a Zener diode 21, a resistor 23 which are the electronic components, a cover 25, a lens 27 for refracting an emitted light from the LED 19, and an electric wire holder 29, as main configuration members.

The housing 13 is molded into a rectangular parallelepiped shape by a synthetic resin. An element mounting space 31 in which the LED 19 is accommodated and a diode mounting space 33 are formed inside the housing 13. The element mounting space 31 and the diode mounting space 33 are opened through an element mounting opening 37 and a diode mounting opening 39 formed on a housing tip end surface 35 that is an outer surface of the housing 13. The housing 13 is formed of a housing back wall 41 on a side opposite to the housing tip end surface 35.

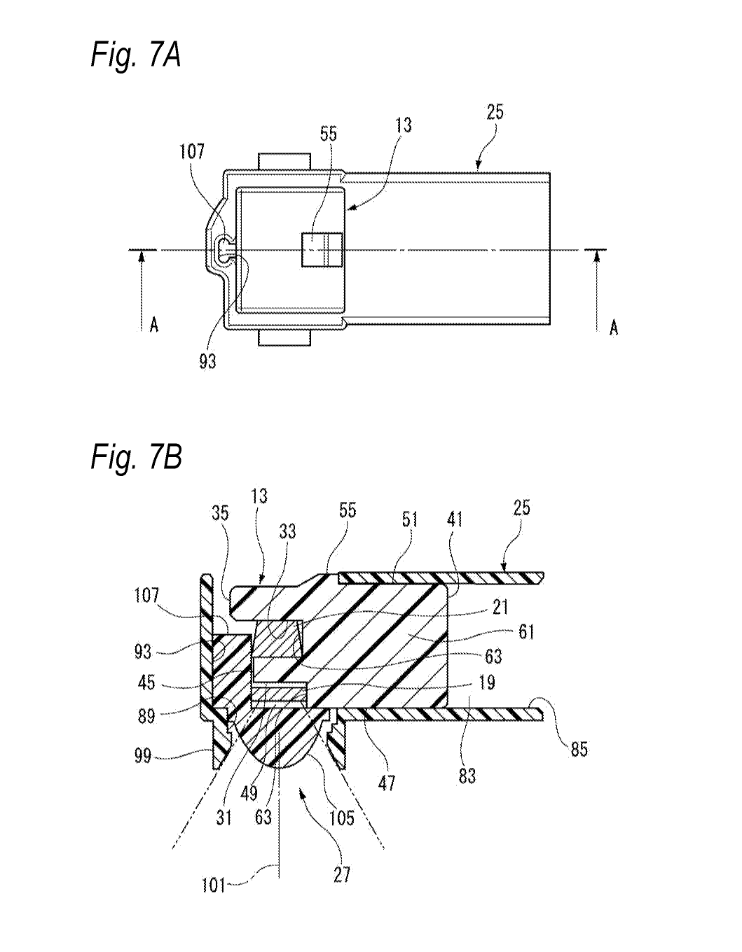

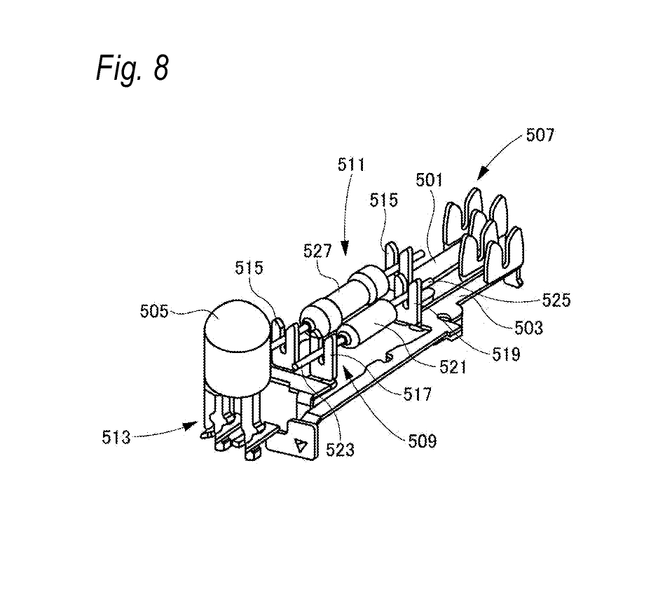

A vertical partition wall 43 is provided between the element mounting opening 37 and the diode mounting opening 39. The vertical partition wall 43 is provided with a guide rod entering groove 45 that is cut from the housing tip end surface 35. In the housing 13, a light emitting opening 49 is opened in a perpendicular outer surface 47 (see FIG. 7B) perpendicular to the housing tip end surface 35 through the element mounting space 31.

Furthermore, in the housing 13, a pair of resistor mounting openings 53 for mounting the resistor 23 is opened to a rear outer surface 51 on a side opposite to the perpendicular outer surface 47. A lock protrusion 55 is protruded on the rear outer surface 51 of the housing 13 and the lock protrusion 55 regulates separation of the housing 13 from the cover 25 by locking to the cover 25.

A busbar accommodating chamber 57 for accommodating the left busbar 15 and the right busbar 17 is formed inside the housing 13. The busbar accommodating chamber 57 is opened through a busbar mounting opening 59 on the perpendicular outer surface 47. A pair of the busbar accommodating chambers 57 are divided into right and left with a housing center wall 61 interposed therebetween.

A surface of the housing center wall 61 facing the element mounting space 31 and the diode mounting space 33 is provided with a positioning section 63 (see FIG. 7B) and the positioning section 63 faces an insertion tip end side of the LED 19 and the Zener diode 21. The Zener diode 21 and the LED 19 are interposed between the positioning section 63 and a guide rod described later which is formed in the lens 27.

In the LED unit 11 of the embodiment, the positioning section 63 is formed by using the housing center wall 61 provided to insulate a pair of the left busbar 15 and the right busbar 17 arranged on the right and left. Thus, a housing structure is compact without forming a dedicated positioning portion.

The LED 19, the Zener diode 21, and the resistor 23 mounted on the housing 13 are the electronic components for surface mounting where a pair of contact sections are provided on one surface thereof.

Each of the left busbar 15 and the right busbar 17 has a first pressure contact section 65 at one end and a second pressure contact section 67 at the other end. A third pressure contact section 69 is provided between the first pressure contact section 65 and the second pressure contact section 67. The left busbar 15 and the right busbar 17 are arranged in parallel by being separated by the housing center wall 61 in the busbar accommodating chamber 57 of the housing 13. A pair of main contact spring pieces 71, which move upward and downward, and are respectively capable of elastically coming into contact with a pair of contact sections of the LED 19 and the Zener diode 21, are respectively arranged in the first pressure contact section 65 of the left busbar 15 and the right busbar 17. Furthermore, a pair of sub-contact spring pieces 73 connected to a pair of contact sections of the resistor 23 are respectively disposed in the third pressure contact sections 69 of the left busbar 15 and the right busbar 17.

In the LED unit 11 of the embodiment, the pair of upward main contact spring pieces 71 adjacent to the left busbar 15 and the right busbar 17 are connected to a pair of contact sections of the Zener diode 21. Furthermore, the pair of downward main contact spring pieces 71 adjacent to the left busbar 15 and the right busbar 17 are connected to a pair of contact sections of the LED 19. Furthermore, in each of the left busbar 15 and the right busbar 17, the pair of sub-contact spring pieces 73 of the third pressure contact section 69 are connected to a pair of the contact sections of the resistor 23.

In a state where the left busbar 15 and the right busbar 17 are mounted on the busbar accommodating chamber 57 of the housing 13, the second pressure contact section 67 are protruded to the outside of the housing 13. The second pressure contact section 67 is provided with a pressure contact blade 77 to be electrically connected to a conductor that is formed by tearing a cover of a covered electric wire 75. The left busbar 15 and the right busbar 17 are configured such that a base end side of the pressure contact blade 77 becomes a rear abutting piece 79. The rear abutting piece 79 abuts the housing back wall 41.

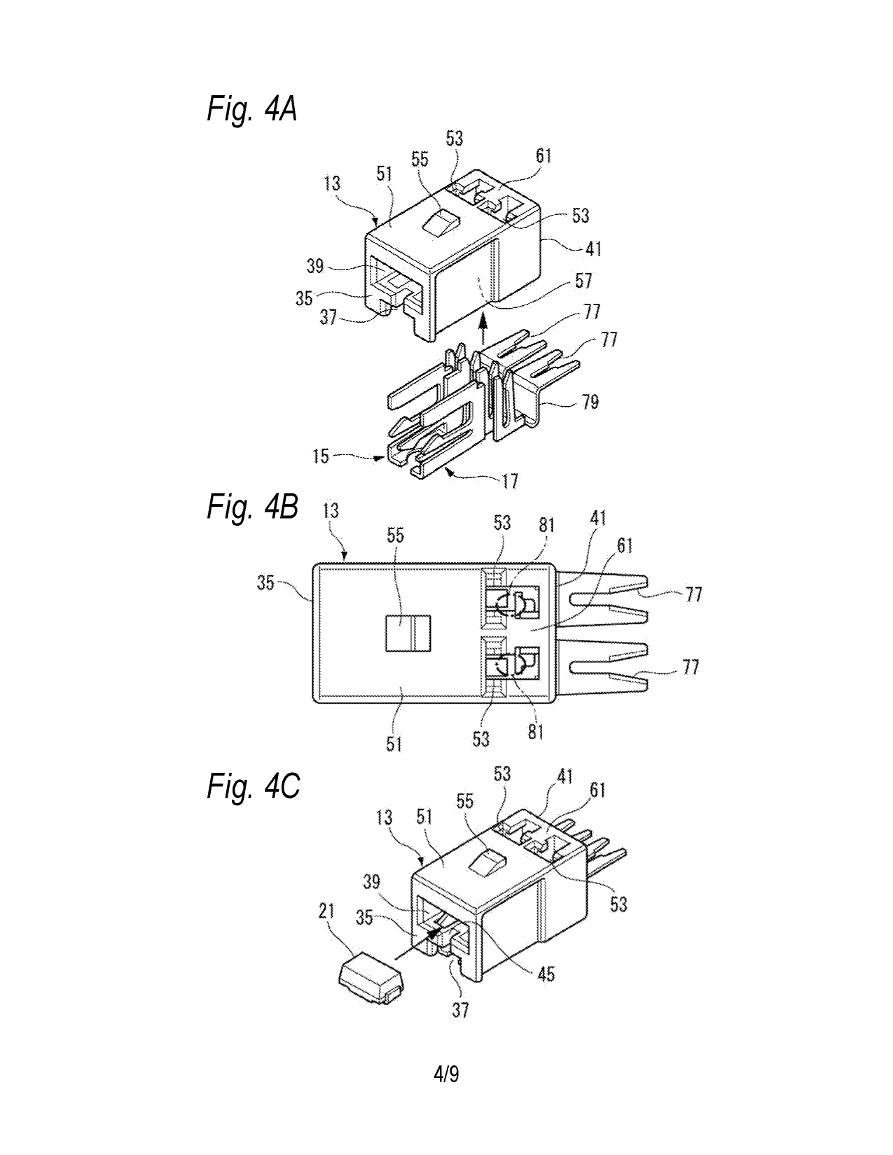

In the LED unit 11 of the embodiment, the LED 19 and the Zener diode 21 are connected in parallel between an anode and a cathode. In such a connection structure of the electronic components, a circuit is assumed in which the resistor 23 is provided between the LED 19, the Zener diode 21, and the anode. In the configuration, the third pressure contact section 69 is configured such that connection sections 81 (see FIG. 4B) between the pair of sub-contact spring pieces 73 respectively connected to the pair of the contact sections of the resistor 23 are separated when connecting to the resistor 23. In each of the left busbar 15 and the right busbar 17, the resistor 23, of which one resistor contact section comes into contact with the pressure contact blade 77 through one sub-contact spring piece 73, is configured such that the other resistor contact section comes into contact with the other sub-contact spring piece 73 by cutting the connection section 81. Thus, a circuit is configured in which the resistor 23 is provided between the second pressure contact section 67 and the third pressure contact section 69 in series.

A surface of the LED 19 on which the contact section is provided faces the main contact spring piece 71 of the upper stage. A surface of the Zener diode 21 on which the contact section is provided faces the main contact spring piece 71 of the lower stage.

In the LED unit 11 of the embodiment, a pitch between contact points of the LED 19 is smaller than a pitch between contact points of the Zener diode 21. That is, the two electronic components have the pitches between the contact points different from each other. In the connection structure of the electronic components of the embodiment, the electronic components having the different pitches between the contact points are simultaneously mounted. That is, the pair of contact sections of the LED 19 come into contact with the pair of the main contact spring pieces 71 adjacent to each other close to the lower stage of two left busbar 15 and right busbar 17, and the pair of the contact sections of the Zener diode 21 come into contact with the pair of the main contact spring pieces 71 adjacent to each other separated in the upper stage thereof.

The cover 25 is molded into a rectangular parallelepiped shape by a synthetic resin. A housing accommodating space 83 is formed inside the cover 25. The housing accommodating space 83 is opened at a housing insertion opening 85 on one end side of the cover 25 in a longitudinal direction. The cover 25 is provided with a lens mounting space 87 for accommodating the lens 27. The cover 25 is mounted on the housing 13 by the housing tip end surface 35 entering the lens mounting space 87. The cover 25 is provided with a lens seating section 89 (see FIG. 7B) on a rear side of the lens mounting space 87. A lens mounting opening 91 is opened in the cover 25 and the lens mounting opening 91 is opened on a side opposite to the lens seating section 89 on the rear side with the housing tip end surface 35, which enters the lens mounting space 87 formed in the cover 25, interposed therebetween.

The cover 25 is provided with a lens insertion guide groove 93 over the lens seating section 89 from the lens mounting opening 91. That is, the lens insertion guide groove 93 is opened to the lens mounting space 87. The lens insertion guide groove 93 is formed in a substantially T-shape of a cross sectional shape. The lens insertion guide groove 93 engages with a guide rod 107 described later formed in the lens 27.

The electric wire holder 29 is mounted on the cover 25 from the housing insertion opening 85 after the housing 13 is mounted. A lock hole 95 is formed in a side portion of the cover 25 and the lock hole 95 locks a lock claw 97 of the electric wire holder 29. The cover 25 is provided with a cylindrical lens hood section 99 matching the light emitting opening 49 of the housing 13. An axis of the lens hood section 99 matches a lens center axis 101 (see FIG. 7B) of the lens 27 mounted on the lens seating section 89. A bayonet section 103 is formed on an outer periphery of the lens hood section 99 and the bayonet section 103 is mounted on a mounting section (not illustrated) so as to be detachable.

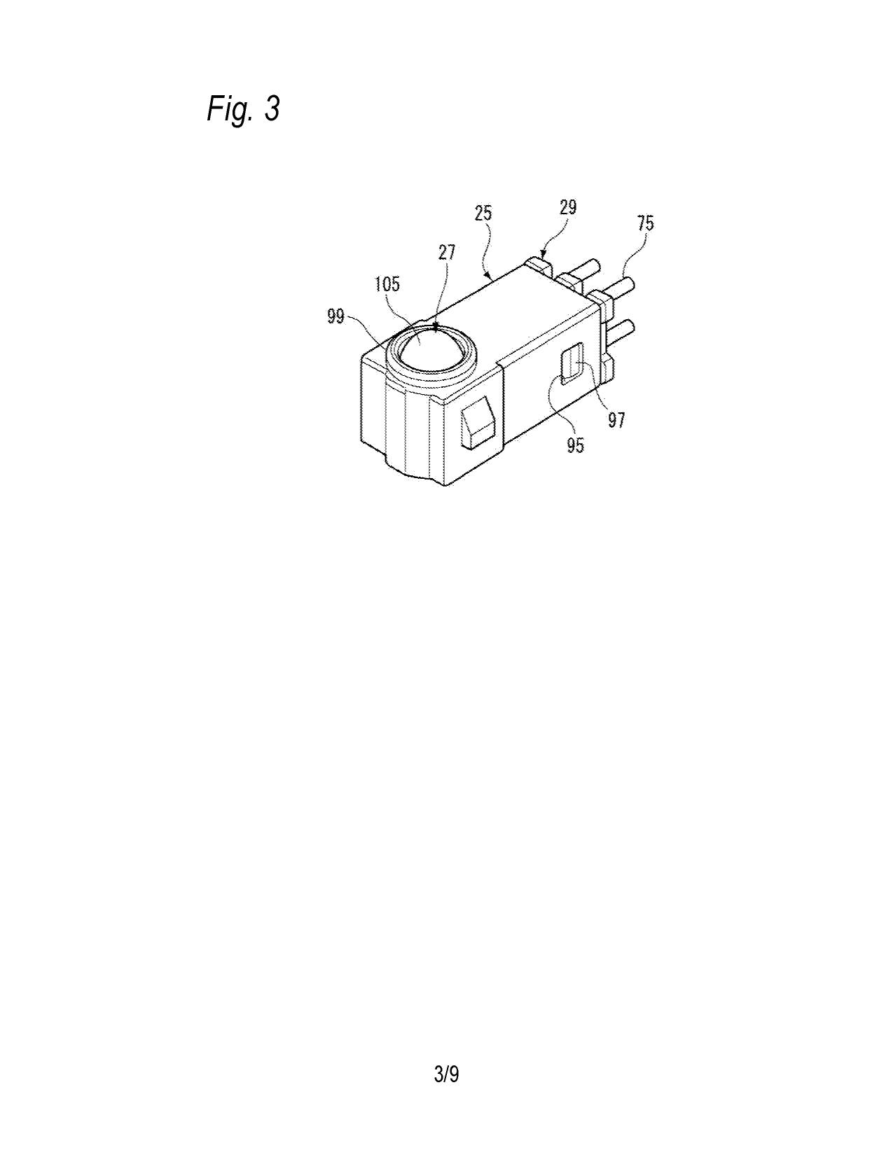

Moreover, as illustrated in FIG. 3, the cover 25 may be formed in a ring shape in which the lens hood section 99 does not have the bayonet section 103.

The lens 27 is formed in a flat plate disk shape in which one surface of a lens body 105 is a convex-curved surface. The guide rod 107, which is protruded from light incident side of the lens 27 along the lens center axis 101 and guides insertion of the lens 27 to the lens seating section 89 by engaging with the lens insertion guide groove 93, is formed in the lens body 105. The guide rod 107, which is integrally formed with the lens body 105 by the same transparent material as the lens body 105, is formed over an inside and an outside thereof with an outer diameter of the lens body 105 interposed therebetween. Moreover, the guide rod 107 separated from the lens body 105 can be integrally formed with the lens body 105 by adhesive and the like.

The guide rod 107 is formed in a substantially T-shape in a cross sectional shape, engages with the lens insertion guide groove 93 to be slidable, and movement thereof is regulated in a direction perpendicular to a sliding direction. The guide rod 107 engaged with the lens insertion guide groove 93 is protruded to the lens mounting space 87. If the cover 25 is mounted on the housing 13, the guide rod 107 protruded to the lens mounting space 87 abuts the Zener diode 21 and the LED 19 mounted on the housing 13. In this case, the guide rod 107 enters the guide rod entering groove 45 that is cut by the vertical partition wall 43 of the housing 13.

The electric wire holder 29 is molded in a block shape by synthetic resin. The u-shaped electric wire holding grooves 109 are formed at two portions on three outer surfaces of the electric wire holder 29. The covered electric wire 75 is bent in a U-shape and is mounted on each of the electric wire holding grooves 109. A horizontal pressure contact blade entering slit 111 is formed on a front surface of the electric wire holder 29 over each of the electric wire holding grooves 109. Thus, if the electric wire holder 29 is inserted into the cover 25, the pressure contact blade 77 protruded towards the rear of the inside of the cover 25 enters the pressure contact blade entering slit 111 and is configured such that the pressure contact blade 77 is connected to the conductor of the covered electric wire 75. The lock claw 97 locked to the lock hole 95 of the cover 25 is protruded to the side surface of the electric wire holder 29.

Next, an assembling procedure of the LED unit 11 having the configuration described above will be described.

When assembling the LED unit 11, as illustrated in FIG. 4A, first, the left busbar 15 and the right busbar 17 are mounted on the housing 13. The left busbar 15 and the right busbar 17 inserted into the busbar accommodating chamber 57 of the housing 13 are mounted on the housing 13 such that the rear abutting piece 79 abuts the housing back wall 41.

After the left busbar 15 and the right busbar 17 are mounted on the housing 13, as illustrated in FIG. 4B, the connection section 81 of the left busbar 15 and the right busbar 17 is cut. The left busbar 15 and the right busbar 17 mounted on the busbar accommodating chamber 57 are configured such that the connection section 81 is positioned in resistor mounting opening 53. Thus, it is possible to easily visible whether or not the connection section 81 is cut. Then, as illustrated in FIG. 4C, the Zener diode 21 is inserted from the diode mounting opening 39 by the contact section on the lower side.

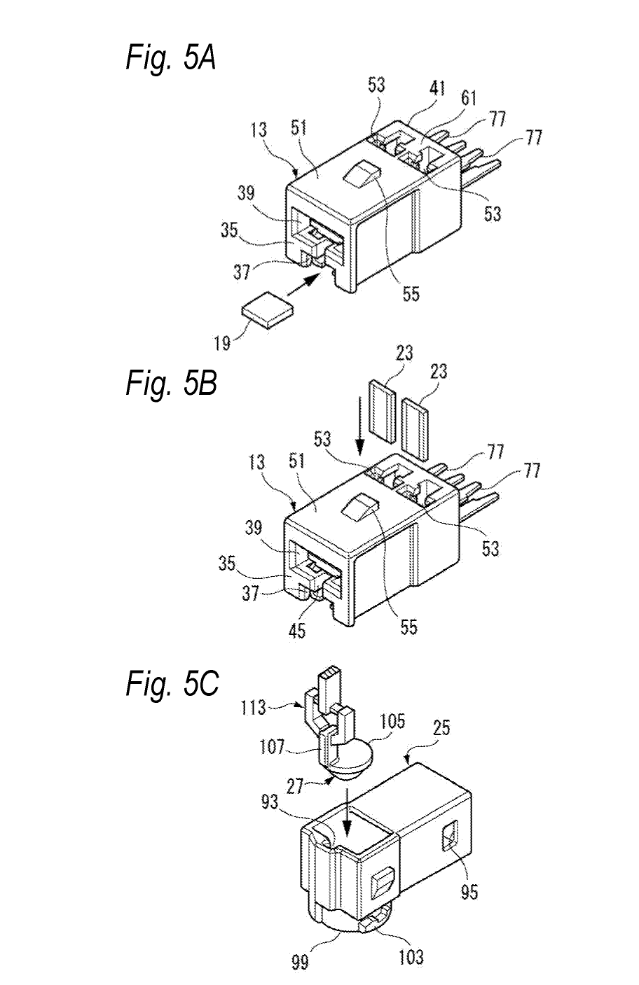

As illustrated in FIG. 5A, the LED 19 is inserted from the element mounting opening 37 by the contact section on the upper side.

As illustrated in FIG. 5B, the resistor 23 is inserted from resistor mounting opening 53. The resistor 23 is inserted in a state where both edge portions are held from resistor mounting opening 53 and thereby the contact section is connected to each of the pair of the sub-contact spring pieces 73.

Next, as illustrated in FIG. 5C, the lens 27 is assembled to the cover 25.

The lens 27 is inserted from the lens mounting opening 91 and thereby the guide rod 107 engages with the lens insertion guide groove 93 in an orientation in which the guide rod 107 protrudes rearward in the inserting direction. In this case, in a case of automatic assembly, the guide rod 107 is held by a chuck 113 and thereby it is possible to easily and reliably hold the lens 27.

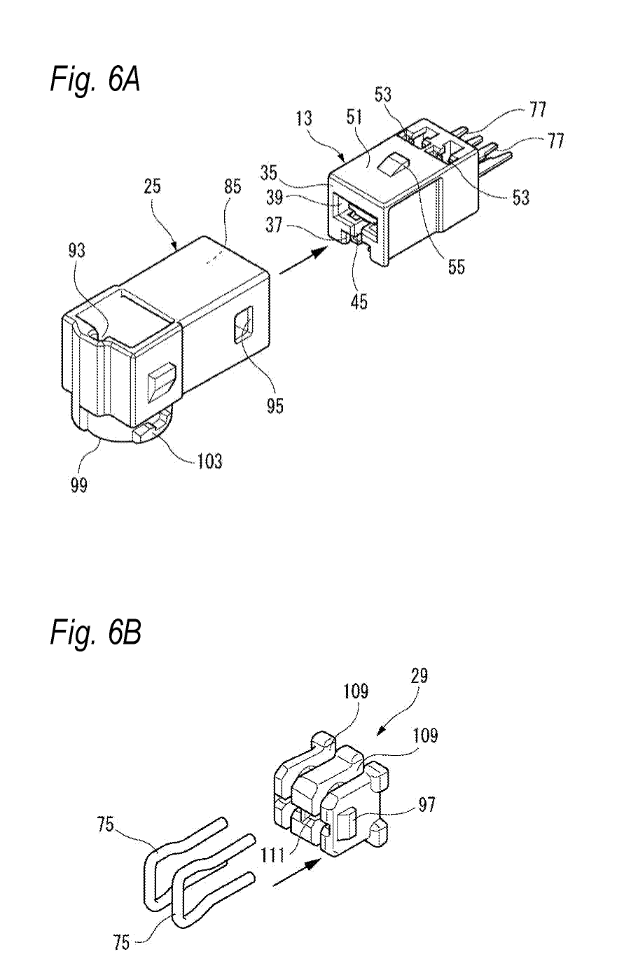

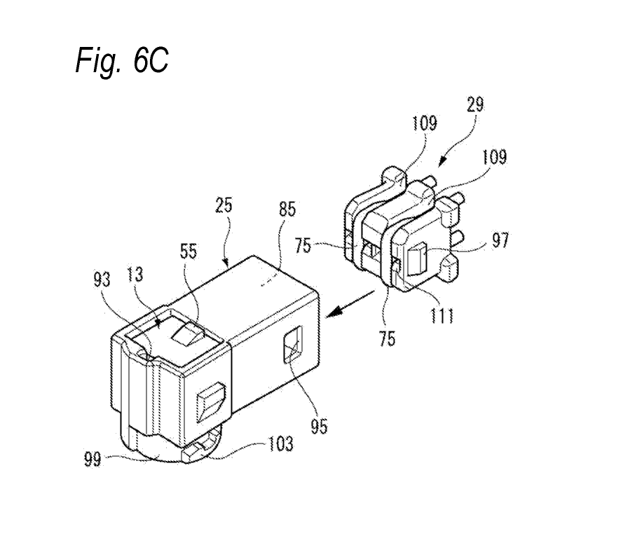

Then, as illustrated in FIG. 6A, the cover 25 on which the lens 27 is mounted, is mounted on the housing 13 in which mounting of the Zener diode 21, the LED 19, and the resistor 23 are completed. If the cover 25 receives the housing 13 from the housing insertion opening 85 and the housing 13 enters to a predetermined position, the lock protrusion 55 of the housing 13 is locked to the cover 25 and the cover 25 and the housing 13 are locked by regulating separation thereof. The housing 13 inserted into the inside of the cover 25 becomes a state where the pressure contact blade 77 is protruded toward the housing insertion opening 85 from the inside thereof.

In this case, the guide rod 107 of the lens 27 mounted on the cover 25 enters the guide rod entering groove 45 of the housing 13. The guide rod 107 entered the guide rod entering groove 45 abuts the Zener diode 21 and the LED 19. If the Zener diode 21 and the LED 19 is not completely mounted on the element mounting space 31, that is, is in a semi-engaged state, the Zener diode 21 and the LED 19 are pressed by the guide rod 107 and are mounted at a normal position.

Next, as illustrated in FIG. 6B, the covered electric wire 75 is assembled to the electric wire holder 29. The covered electric wire 75 is bent in the U-shape and is mounted on the electric wire holding groove 109.

Next, as illustrated in FIG. 6C, the electric wire holder 29 is assembled from the housing insertion opening 85 of the cover 25. The horizontal pressure contact blade entering slit 111 is formed on the front surface of the electric wire holder 29 over each of the electric wire holding grooves 109. Thus, if the electric wire holder 29 is inserted into the cover 25, the pressure contact blade 77 protruded inward and toward the rear of the cover 25 enters the pressure contact blade entering slit 111 and the pressure contact blade 77 is connected to the conductor of the covered electric wire 75.

Then, the electric wire holder 29 inserted into the cover 25 is configured such that the lock claw 97 protruded in the side surface is locked to the lock hole 95 formed in the side portion of the cover 25 and separation from the cover 25 is regulated. Thus, the housing 13, the cover 25, and the electric wire holder 29 are integrated and assembly of the LED unit 11 on which the lens 27, the Zener diode 21, the LED 19, and the resistor 23 are mounted is completed.

Next, an operation of the LED unit 11 including the lens accommodating structure having the configuration described above will be described.

According to the LED unit 11 of the embodiment, the guide rod 107 is protruded from the light incident side of the lens 27 along the lens center axis 101 and in the automatic assembly, the guide rod 107 is gripped by the chuck 113 and the lens 27 can be reliably held in a desired posture. The lens 27 in which the guide rod 107 is gripped is inserted into the lens mounting space 87 from the lens mounting opening 91 and is easily mounted on the lens seating section 89 on the rear side while the guide rod 107 is engaged with and guided to be inserted into the lens insertion guide groove 93 of the cover 25.

The cover 25 is mounted on the housing 13 on which the LED 19 is mounted in a state where the lens 27 is mounted. If the cover 25 is mounted on the housing 13, the housing tip end surface 35 of the housing 13 enters the lens mounting space 87. The element mounting opening 37 is opened to the housing tip end surface 35. Here, if the LED 19 is not completely mounted on the element mounting space 31, the insertion rear end section is in a state of protruding from the element mounting opening 37. If the housing tip end surface 35 enters the lens mounting space 87, the LED 19 in which the insertion rear end section protrudes from the element mounting opening 37 abuts the guide rod 107 engaging with the lens insertion guide groove 93.

If the cover 25 is mounted on the housing 13 to a predetermined position, the LED 19 is pressed to a predetermined position of the element mounting space 31 by the guide rod 107 abutting the insertion rear end section and a regular mounting position illustrated in FIG. 7B is formed. In this case, since the LED 19 is directly pressed by the guide rod 107 integrally formed with the lens 27, an error in a relative position with the lens 27 is unlikely to occur. That is, the relative position of the LED 19 is determined with respect to the lens 27 with high precision.

Furthermore, the LED unit 11 of the embodiment has a size relationship in which the LED 19 is disposed on the inside of the outer diameter of the lens and the guide rod 107 is formed to protrude to the inside from the outer diameter of the lens of the lens body 105. Here, since the guide rod 107 is integrally molded with the lens body 105 with the same transparent material as the lens body 105, the light is not blocked until the light is incident on the lens body 105 of the lens 27. Thus, light use efficiency is not lowered even in a case where the guide rod 107 is disposed between a light emitting section of the LED 19 and light incident side of the lens.

Furthermore, in the LED unit 11 including the lens accommodating structure of the embodiment, the LED 19 pressed by the guide rod 107 of the lens 27 abuts the positioning section 63 and is not pressed to a predetermined position or more. The LED 19 is clamped by the guide rod 107 and the positioning section 63 and thus the LED 19 is unlikely to move due to vibration or impact, and fixing reliability is increased. Furthermore, if the LED 19 and the Zener diode 21 are semi-engaged, as described above, if the cover 25 is mounted on the housing 13 to the regular position, the LED 19 and the Zener diode 21 are pressed to the regular position by the guide rod 107, and reliable mounting is always realized.

Thus, according to the LED unit 11 including the lens accommodating structure of the embodiment, the LED 19 and the lens 27 can be relatively easily positioned.

Moreover, the invention is not limited to the embodiments described above and suitable modifications, improvements, and the like are possible. In addition, a material, a shape, a dimension, the number, a disposition position, and the like of each configuration element in the embodiments described above are not limited and are arbitrary as long as they can achieve the invention.

Here, characteristics of the embodiments of the semiconductor light source unit and the vehicle lighting device of the invention are respectively briefly described as the following [1] to [3].

[1] A lighting apparatus (LED unit) 11 includes

a semiconductor light emitting device (LED) 19,

a housing 13 in which an element mounting opening 37 of an element mounting space 31 accommodating the semiconductor light emitting device (LED) 19 is opened in one outer surface (housing the tip end surface) 35 and in which a light emitting opening 49 communicated with the element mounting space 31 is provided in a perpendicular outer surface 47 perpendicular to the one outer surface (housing the tip end surface) 35;

a cover 25 that allows the one outer surface (housing the tip end surface) 35 to enter a lens mounting space 87 accommodating a lens 27 for refracting an emitted light from the semiconductor light emitting device (LED) 19 and is mounted on the housing 13;

a lens mounting opening 91 that is formed in the cover 25 and is opened on a side opposite to a lens seating section 89 on a rear side with the one outer surface (housing the tip end surface) 35 entered in the lens mounting space 87 interposed therebetween;

a lens insertion guide groove 93 that is formed over the lens seating section 89 from the lens mounting opening 91; and

a guide rod 107 that protrudes from a light incident side of the lens 27 along a lens center axis 101, engages with the lens insertion guide groove 93 so as to guide insertion of the lens 27 to the lens seating section 89, and abuts the semiconductor light emitting device (LED) 19 when the cover 25 is mounted on the housing 13.

[2] In the lighting apparatus (LED unit) 11 of the configuration of the above the guide rod 107 is integrally molded with the lens 27 by a transparent material.

[3] In the lighting apparatus (LED unit) 11 of the configuration of the above [1] or [2],

a positioning section 63 is formed in the element mounting space 31 with the semiconductor light emitting device (LED) 19 interposed between the guide rod 107 and the positioning section 63.

According to the lighting apparatus including the lens accommodating structure of the invention, it is possible to relatively easily position the semiconductor light emitting device and the lens.

What is claimed is:

1. A lighting apparatus comprising:
a semiconductor light emitting device;
a housing in which an element mounting opening of an element mounting space accommodating the semiconductor light emitting device is opened in one outer surface and in which a light emitting opening communicated with the element mounting space is provided in a perpendicular outer surface perpendicular to the one outer surface;
a cover that allows the one outer surface to enter a lens mounting space accommodating a lens for refracting an emitted light from the semiconductor light emitting device and is mounted on the housing;
a lens mounting opening that is formed in the cover and is opened on a side opposite to a lens seating section on a rear side with the one outer surface entered in the lens mounting space interposed therebetween;
a lens insertion guide groove that is formed over the lens seating section from the lens mounting opening; and
a guide rod that protrudes from a light incident side of the lens along a lens center axis, engages with the lens insertion guide groove so as to guide insertion of the lens to the lens seating section, and abuts the semiconductor light emitting device when the cover is mounted on the housing.

2. The lighting apparatus according to claim 1,
wherein the guide rod is integrally molded with the lens by a transparent material.

3. The lighting apparatus according to claim 1,
wherein a positioning section is formed in the element mounting space with the semiconductor light emitting device interposed between the guide rod and the positioning section.
